(19) United States
(12) Patent Application Publication
(10) Pub. No.: US 2016/0336100 A1
(43) Pub. Date: Nov. 17, 2016

(54) WOUND CORE AND METHOD FOR MANUFACTURING WOUND CORE

(71) Applicant: TOSHIBA INDUSTRIAL PRODUCTS & SYSTEMS CORPORATION, KANAGAWA (JP)

(72) Inventors: Hiromu SHIOTA, Mie (JP); Tsuyoshi MASUDA, Mie (JP); Yoshinori YAMAZAKI, Mie (JP); Takashi IKEDA, Mie (JP)

(73) Assignee: TOSHIBA INDUSTRIAL PRODUCTS & SYSTEMS CORPORATION, KANAGAWA (JP)

(21) Appl. No.: 15/221,259

(22) Filed: Jul. 27, 2016

Related U.S. Application Data
(63) Continuation of application No. PCT/JP2014/082841, filed on Dec. 11, 2014.

(30) Foreign Application Priority Data
Jan. 27, 2014 (JP) 2014-012416

(51) Int. Cl. H01F 3/04; H01F 41/02

(52) U.S. Cl. CPC H01F 3/04; H01F 41/02

(57) ABSTRACT

A wound core is provided with plural wound core materials each having at least one cut portion for every one winding thereof. The wound core is provided with a rectangular window portion at the center thereof. A space factor of the core materials at each of corner portions is less than a space factor of the core materials at each of side portions.

### CROSS-REFERENCE TO RELATED APPLICATION(S)

This application is a continuation to an International Application No. PCT/JP2014/082841, filed on Dec. 11, 2014 which is based upon and claims the benefit of priority from Japanese Patent Application No. 2014-012416, filed on, Jan. 27, 2014 the entire contents of which are incorporated herein by reference.

### FIELD

Embodiments disclosed herein relate to a wound core comprising plural wound core materials and a method of manufacturing the wound core.

### BACKGROUND

One of the major technical trends in compact distribution transformers for example is promotion of energy saving and efficiency. In Japan, the so-called top runner program has been put into practice. A standard for achieving high efficiency for example has also been established worldwide. Efforts have been made in a global scale in particular to reduce the so-called “iron loss” which is known as a no-load loss or power loss occurring at the core. There is an intense competition between the manufacturers to provide improved core materials and improved core structures. Examples of a transformer core include a laminated core and a wound core. The laminated core is a laminate of cut thin plates made of silicon steel. The wound core is a wound structure of cut thin plates made of silicon steel. The wound core is advantageous over the laminate core in terms of reducing iron loss since the flow of magnetic flux inside the core is less likely to be interrupted.

For example, JP H05-159953 A discloses one example of a method of manufacturing such wound core. The disclosed type of wound core is generally manufactured as follows. Core materials are cut one by one each in the length of one winding amount, i.e. length of one turn from a thin silicon steel plate and are wound into a circular winding mold. Then, the inner side and the outer side of the wound core materials are pressed by a mold to form a substantially rectangular window portion at the center. At this instance, bending stress causing an increase in iron loss is exerted on the core material of the wound core. In order to relax residual stress and restore iron-loss characteristics, an annealing process is carried out in which the wound core is cooled after being heated for example to approximately 800 degrees Celsius. When assembling the coil with the wound core, each of the core materials of the wound core is tentatively opened at their cut portion. Then, the coil is assembled with the sides of the wound core. The wound core is thereafter closed. When a gap is created at the joint portion where the cut portion of each core material is rejoined, the shape of the wound core becomes distorted for example and causes an increase in iron loss. Thus, a tightening band is placed around the wound core in attempt to prevent creation of gap as much as possible.

The gap created at the joint portion where the cut portion of each core material is joined needs to be minimized in order to inhibit increase of iron loss of the wound core. Thus, a precise dimensional control is required in the series of steps for manufacturing the wound core, namely, the silicon steel plate cutting step, winding step, molding step, annealing step, and the coil assembly step. The wound core needs to be tightened as described above in the coil assembly step. This is leading to an increase in the manufacturing steps.

### SUMMARY

In one embodiment, a wound core capable of inhibiting increase in iron loss and a method of manufacturing such wound core is provided. According to the embodiment, the wound core can be manufactured without requiring precise dimensional control in the manufacturing steps and without causing increase in manufacturing steps.

In one embodiment, a wound core is provided with plural wound core materials each having at least one cut portion for every one winding thereof, the wound core being provided with a rectangular window portion at the center thereof. The wound core is provided with corner portions provided at four corners of the window portion; and side portions connecting the corner portions. A space factor of the core materials at each of the corner portions is less than a space factor of the core materials at each of the side portions.

In one embodiment, a method of manufacturing a wound core includes loosely winding plural core materials each having at least one cut portion for every one winding thereof; and closing the at least one cut portion of each core material to form a rectangular window portion at the center of each core material and thereby causing a space factor of the core material in corner portions of the core material to be less than a space factor of the core material in side portions of the core material.

A method of manufacturing a wound core in which plural core materials, each having at least one cut portion for every one winding thereof and having portions forming corner portions thereof being bent, are loosely laminated, and in which the at least one cut portion of each core material is closed to form a rectangular window portion at the center of each core material and thereby causing a space factor of the core material in corner portions of the core material to be less than a space factor of the core material in side portions of the core material. The method bends the core materials prior to laminating the core materials and thereby causes the portions forming the side portions of one core material to be longer by a prescribed length than portions forming the side portions of another core material located in an inner side of the one core material, and causes the portions forming the corner portions of one core material to be longer by a prescribed length than portions forming the corner portions of another core material located in an inner side of the one core material.

### BRIEF DESCRIPTIONS OF THE DRAWINGS

FIG. 1 pertains to a first embodiment and is a general view illustrating one example of the structure of a wound core.

FIG. 2 is an enlarged view illustrating one example of the structure of the corner portion and its periphery.

FIG. 3 is an enlarged view illustrating one example of a structure of a joint portion and its periphery.

FIG. 4 is a view indicating one example on the relation of size of the perimeters of adjacent core materials.

FIG. 5 is an overall view illustrating one example of a structure of a manufacturing apparatus of a wound core.

FIG. 6 is a view illustrating one example of a molding step of the wound core.

FIG. 7A is a view illustrating one example of a coil assembly step (part 1).

FIG. 7B is a view illustrating one example of the coil assembly step (part 2).

FIG. 7C is a view illustrating one example of the coil assembly step (part 3).

FIG. 7D is a view illustrating one example of the coil assembly step (part 4).

FIG. 8 pertains to a second embodiment and is a general view illustrating one example of the structure of the wound core.

FIG. 9 is an enlarged view illustrating one example of the structure of the corner portion and its periphery.

FIG. 10 is a view indicating one example on the location of bends of adjacent core materials.

FIG. 11 is a view illustrating one example of a molding step of the wound core.

FIG. 12 pertains to a modified example of the first embodiment and is an enlarged view illustrating one example of the structure of the corner portion and its periphery.

FIG. 13 pertains to a modified example of the second embodiment and is an enlarged view illustrating one example of the structure of the corner portion and its periphery.

### DESCRIPTION

Embodiments of a wound core and a method of manufacturing the wound core are described herein with reference to the drawings. Elements that are substantially identical across the embodiments are identified with identical reference symbols and are not re-described.

### First Embodiment

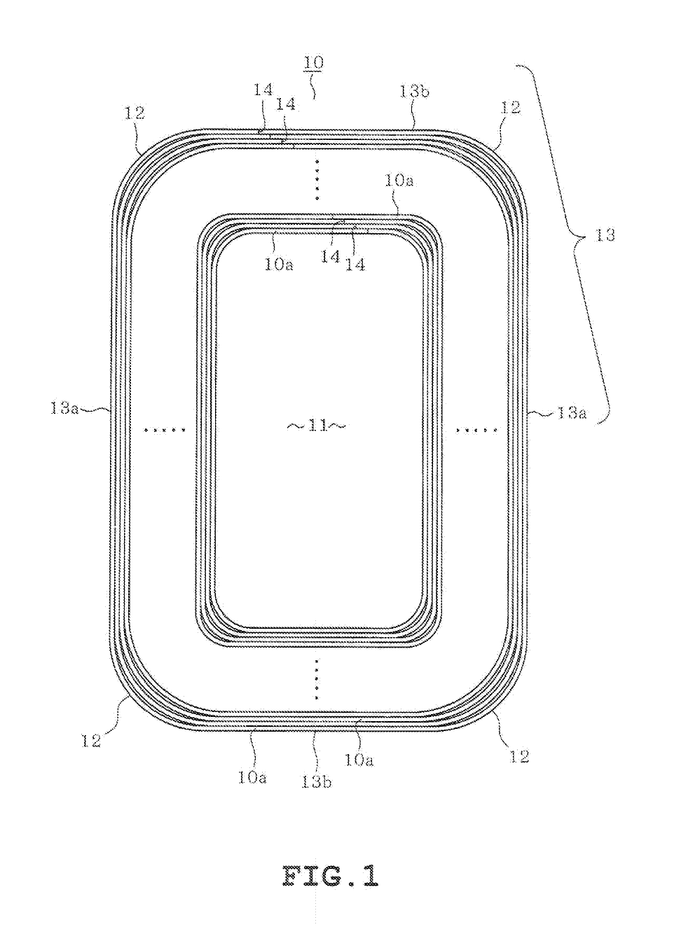

A wound core 10 illustrated in FIG. 1 for example is configured by winding plural core materials 10a obtained by cutting a silicon steel plate not illustrated. A substantially rectangular window portion 11 is provided at the center of the wound core 10. The wound core 10 is provided with four corner portions 12 located at the four corners of the window portion 11 and four side portions 13 exclusive of the corner portions 12. The side portions 13 connect the corner portions 12. The side portions 13 are configured by long side portions 13a with which coils not shown are assembled and short side portions 13b shorter than the long side portions 13a. The plural core materials 10a forming the wound core 10 are each cut in the length of one winding amount, i.e. in the length of one turn from the silicon steel plate. Thus, there is one cut portion for every one winding of core material 10a. A joint portion 14 is formed on each of the two ends of each core material 10a where the cut portion of each core material 10a is joined.

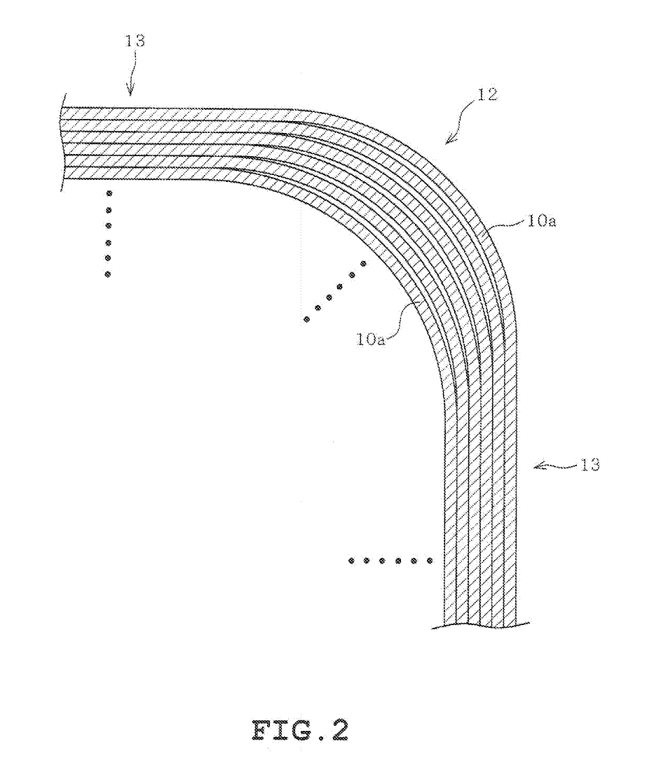

In the example of the wound core 10 illustrated in FIG. 2, the space factor of the core material 10a in the corner portion 12 is less than the space factor of the core material 10a in the side portion 13. The core material 10a is densely laminated in the side portion 13 whereas in the corner portion 12, the core material 10a is not densely laminated, leaving clearance between each of the wound cores 10a. In this example, clearance is provided between each of the core materials 10a. Space factor indicates the percentage that area of core material 10a occupies with respect to the cross-sectional area of the wound core 10. Greater space factor indicates greater density of lamination of the core materials 10a.

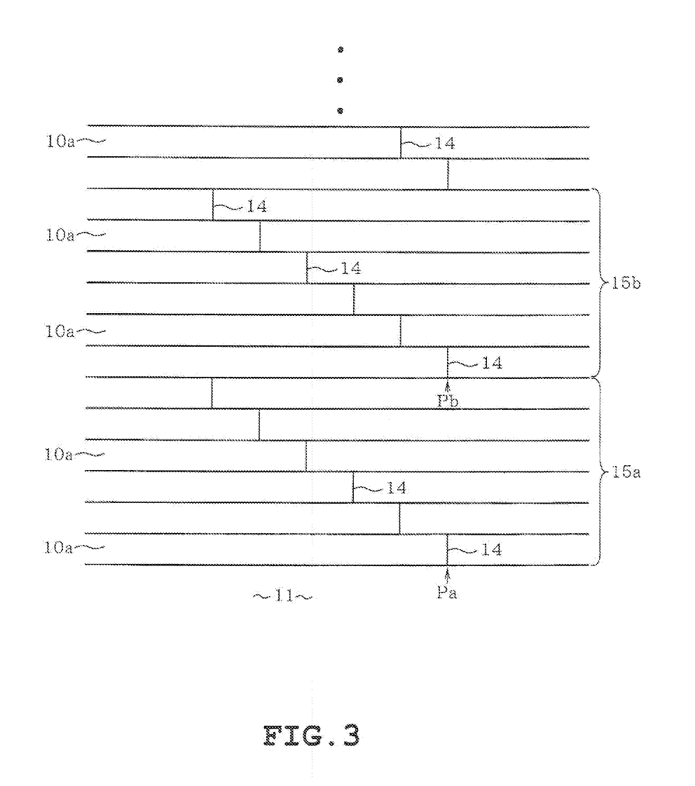

In the example of the wound core 10 illustrated in FIG. 3, every prescribed number of core materials 10a are organized into groups such as core material group 15a, 15b, . . . . More specifically, one core material group 15a, 15b, . . . is formed whenever prescribed number of core materials 10a are laminated from the inner side located closest to the window portion 11 side. The number of core materials 10a being organized into a single core material group may be modified as required. Further, the number of core materials 10a within the core material groups may differ.

The core materials 10a contained in each core material group 15a, 15b, . . . are wound so that the joint portions 14 where the cut portions are joined are circumferentially shifted from one another so as to look like a stairway. For example, location Pb of the joint portion 14 of the core material 10a wound in the innermost side of the core material group 15b is substantially or completely in alignment with location Pa of the joint portion 14 of the core material 10a wound in the innermost side of the core material group 15a adjacent to the inner side of the core material group 15b.

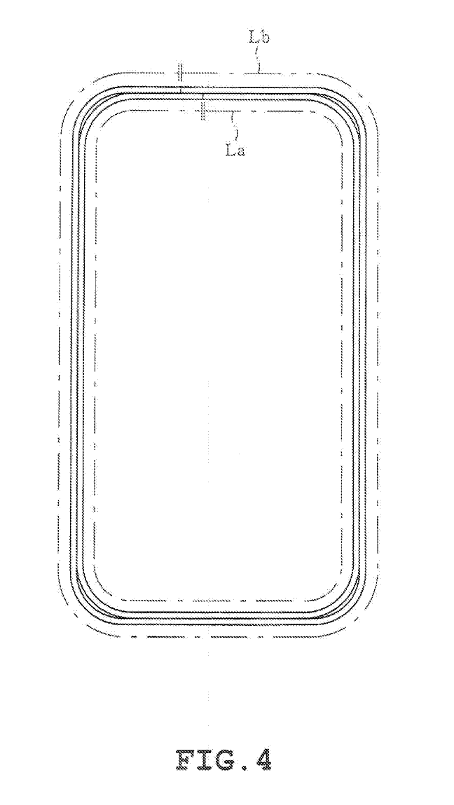

As illustrated in FIG. 4 for example., perimeter Lb of the core material 10a wound in the innermost side of the core material group 15b is greater than perimeter La of the core material 10a wound in the outermost side of the core material group 15a adjacent to the inner side of the core material group 15b. Perimeter Lb is specified so as to be longer than perimeter La by a length corresponding to thickness d of the core material 10a to satisfy the relation represented by the following equation (1). In the equation, “n” represents a circumference ratio whereas “α” represents a variable which may be modified as required.

Lb=La+πd+α (1)

Next, a description will be given on one example of a method of manufacturing the wound core 10 having a low space factor in the corner portions 12. The method includes a silicon steel plate cutting step, core material winding step, wound core molding step, and a wound core annealing step.

<<Silicon Steel Plate Cutting Step>>

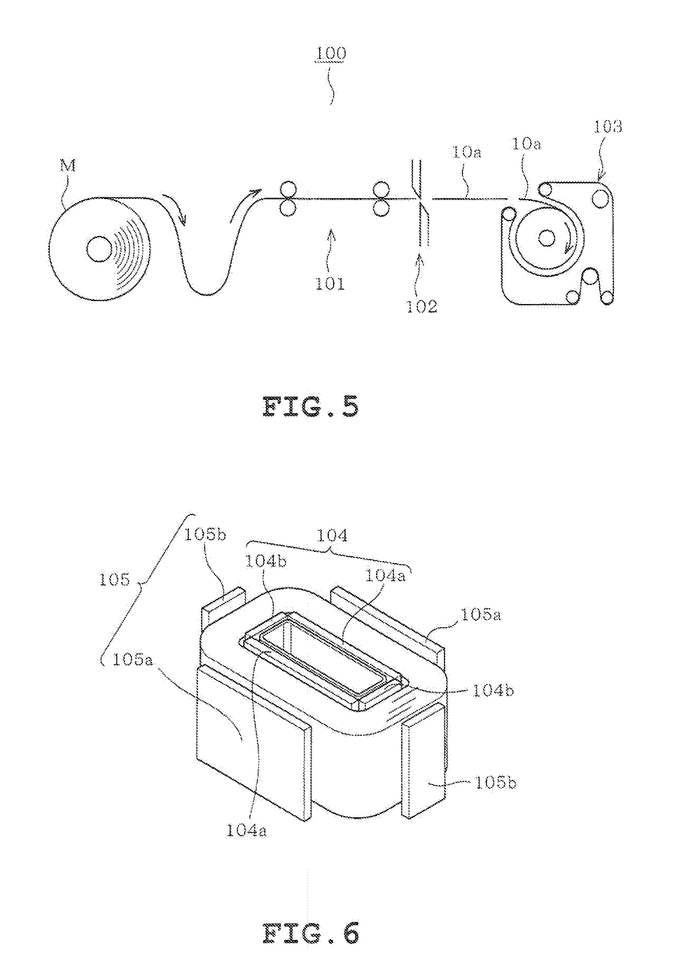

In this step, the manufacturing apparatus 100 is configured to sequentially feed silicon steel strips M by a feeder 101 as illustrated for example in FIG. 5. Using a cut blade 102, the manufacturing apparatus 100 sequentially cuts a length of one winding amount, i.e. one turn of core material 10a from the silicon steel strips M being fed.

<<Core Material Winding Step>

In this step, the manufacturing apparatus 100 sequentially winds the core material 10a obtained from the silicon steel strip M into a circular winding mold 103 as illustrated for example in FIG. 5. At this instance, the core materials 10a are loosely wound compared to the conventional configuration. The magnitude in which the core material 10a is loosened may be controlled based on the targeted space factor of the corner portions 12 of the wound core 10. It is possible to reduce the space factor of the corner portions 12 as the core material 10a is loosened in greater magnitudes.

<<Wound Core Molding Step>>

In this step, molds 104, 105 are placed in contact with four locations of the inner side and four locations of the outer side of the plural core materials 10a being wound and laminated as illustrated for example in FIG. 6. The four locations of the core material 10a are pressed along the direction of lamination by molds 104 and 105. The pressing is performed with the cut portions of the core material 10a placed in the joined state. By pressing the four locations of the core materials 10a, the side portion 13 is formed in each of the pressed portions, that is, the portions clamped between the molds 104, 105. Corner portion 12 is formed in each of the remaining portions, i.e. portions that are not pressed. At this instance, “portions that are not pressed” when stated differently are portions that are not clamped between molds 104, 105.

Because the core materials 10a are loosely wound compared to the conventional configuration, the core materials 10a located in the portions where the corner portions 12 are formed become deformed when pressed. The deformation of the corner portion 12 absorbs the deformation of the core materials 10a originating from the pressing. It is thus, possible to prevent the cut portions of each of the core materials 10a, in other words, the joint portions 14 from opening after pressing.

The molds 104, 105 are formed of a pair of long side molds 104a, 105a and a pair of short side molds 104b, 105b. Long side portions 13a are formed in the portions pressed by long side molds 104a and 105a and short side portions 13b are formed in the portions pressed by short side molds 104b and 105b. The joint portion 14 is formed so as to be located on the short side portion 13b. That is, each of the core materials 10a are pressed with the portions forming the joint portions 14 being clamped between the short side molds 104b, 105b.

<<Wound Core Annealing Step>>

In this step, the wound core 10 is heated to a prescribed temperature of for example, 800 degrees Celsius and thereafter cooled. It is thus, possible to relax residual stress exerted on each of the core materials 10a of the wound core 10 and prevent degradation of iron-loss characteristics of the wound core 10 originating from residual stress. Each of the core materials 10a may become slightly deformed as the result of the residual stress being removed. Such deformation, if any, are absorbed by the deformation of the corner portions 12 exhibiting low space factors. It is thus, possible to prevent the joint portions 14 from being opened by the annealing step.

The above described steps produce the wound core 10 in which the space factor of the core material 10a in the corner portion 12 is less than the space factor of the core material 10a in the side section 13. In the wound core 10, the joint portions 14 formed by each of the core materials 10a are not opened at all and a gap is either only slightly formed at the joint portion 14 or not formed at all.

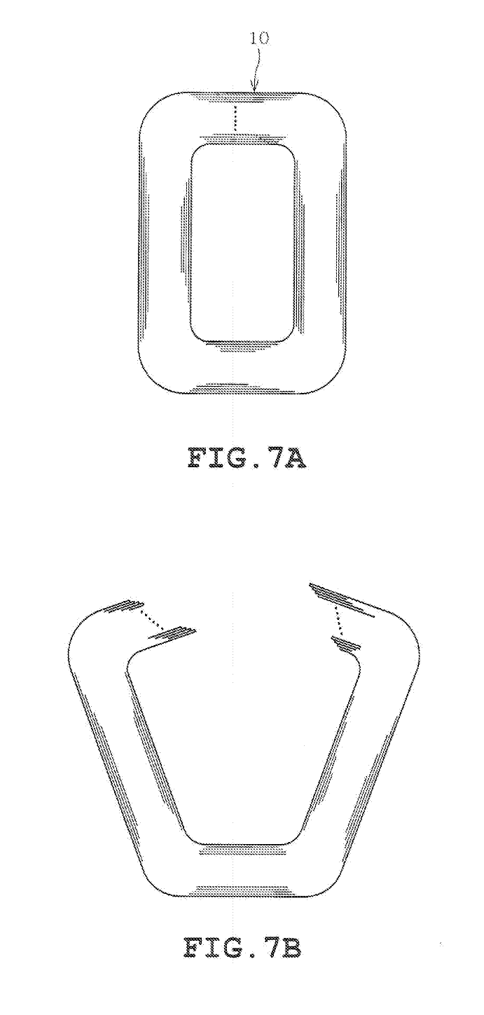

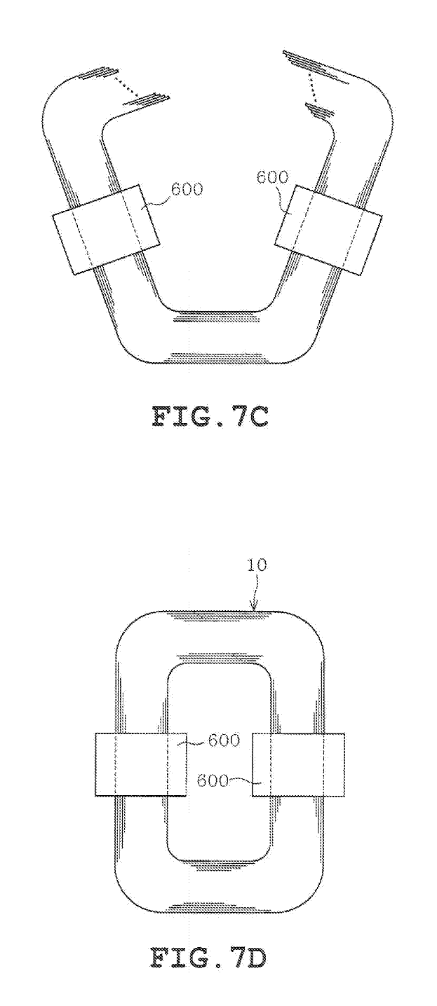

Next, a description will be given on the assembly step in which the coil is assembled with the wound core 10. In the coil assembly step, the wound core 10 illustrated for example in FIG. 7A is tentatively opened at the cut portion, in other words, the joint portion 14 of each core material 10a as illustrated in FIG. 7B. Then, as illustrated in FIG. 7C, a coil 600 is assembled with the long portion 13a. Then, as illustrated in FIG. 7D, the wound core 10 is closed so that the cut portion of each of the core materials 10a is closed. The wound core 10 having coils 600 assembled with the long sides 13a thereof is manufactured in the above described manner.

As described above, there is no gap formed at the joint portion 14 of each core material 10a before the wound core 10 is opened. It is thus, possible to reproduce the wound core 10, having the coil 600 being assembled therewith, with no gaps formed at the joint portions 14 by returning the wound core 10 to its original shape by closing the wound core 10 once opened. Thus, it is no longer necessary to undertake the conventionally required task of tightening the gap of the joint portion 14, that is, tightening the periphery of the wound core 10 with a tightening band when closing the wound core 10. As a result it is possible to reduce the manufacturing steps.

According to the present embodiment, the space factor of the corner portions provided in the core material of the wound core 10 is less than the space factor of the side portions provided in the portions of the core material exclusive of the corner portions. Thus, even if deformation occurs for example at the core material 10a as the result of molding or tightening the wound core 10, it is possible to absorb the deformation at the corner portions and prevent the joint portions 14 from opening. It is thus, possible to manufacture good wound cores 10 with closed joint portions 14 without having to execute precise dimensional control in each of the manufacturing steps. It is further possible to eliminate the wound core tightening step after assembling the coil for example and thereby allow the manufacturing of the wound core 10 without causing increase in the manufacturing steps. It is further possible to prevent the joint portions 14 of the manufactured wound cores 10 from opening and thereby prevent increase in iron loss.

Further according to the present embodiment, the wound core 10 is organized by core material groups 15a, 15b, . . . each containing prescribed number of core materials 10a. The core materials 10a contained in each of the core material groups 15a, 15b, . . . are wound so that the joint portions 14 where the cut portions are joined are circumferentially shifted from one another so as to look like a stairway. Further, the location of the joint portion 14 of the core material 10a of the wound core 10 wound in the innermost side of one core material group is substantially or completely in alignment with the location of the joint portion 14 of the core material 10a wound in the innermost side of another core material group adjacent to the inner side of the one core material group. The wound core 10 is configured so that the portions where the joint portions are formed are shifted in the circumferential direction to look like a stairway. As a result, it is possible to circumferentially shift the joint portions 14 where the magnetic resistance of magnetic path become relatively large and thereby make the flow of magnetic flux at the wound core 10 to be smooth.

Further according to the present embodiment, the perimeter of the core material 10a wound in the innermost side of one core material group is greater than perimeter of the core material 10a wound in the outermost side of the core material group adjacent to the inner side of the one core material group. It is thus, possible to reliably reduce the space factor of the corner portion 12. It is further possible to quantitatively reduce the space factor of the corner portions 12 by controlling the perimeter of each core material 10a.

Further according to the manufacturing method of the wound core of the present embodiment, plural core materials 10a each having one cut portion for every one winding thereof are wound loosely at least compared to conventional configuration and a rectangular window portion 11 is formed in the center with the cut portions of each of the core materials 10a joined. According to the manufacturing method, it is possible to carry out steady manufacturing of wound cores 10 in which the space factor of the core material 10a in the corner portion 12 is less than the space factor of the core material 10a in the side portion 13 exclusive of the corner portions 12.

### Second Embodiment

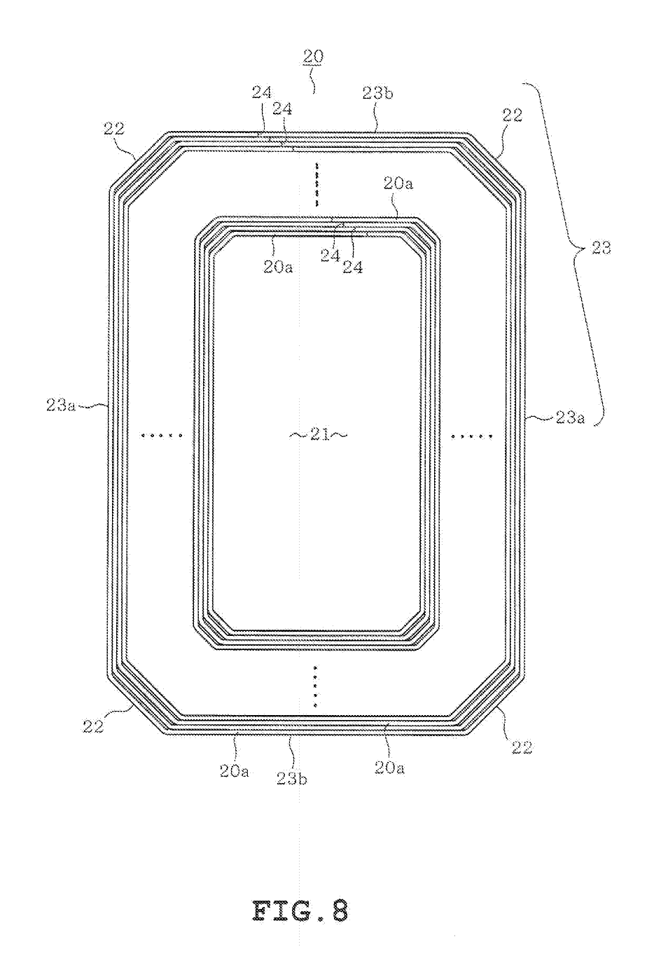

The wound core 20 illustrated for example in FIG. 8 is a structure formed by winding plural core materials 20a obtained by cutting a silicon steel plate not illustrated. A substantially rectangular window portion 21 is provided at the center of the wound core 20. The wound core 20 is provided with four corner portions 22 located at the four corners of the window portion 21 and four side portions 23 which are exclusive of the corner portions 22. The side portions 23 connect the corner portions 22. The side portions 23 are configured by long side portions 23a being assembled with coils not illustrated and short side portions 23b shorter than the long side portions 23a. The plural core materials 20a forming the wound core 20 are each cut in the length of one winding amount, i.e. the length of one turn from the silicon steel plate. Thus, there is one cut portion for each one winding of the core material 20a. A joint portion 24 is formed on the two ends of each core material 20a where the cut portion of each core material 20a is joined.

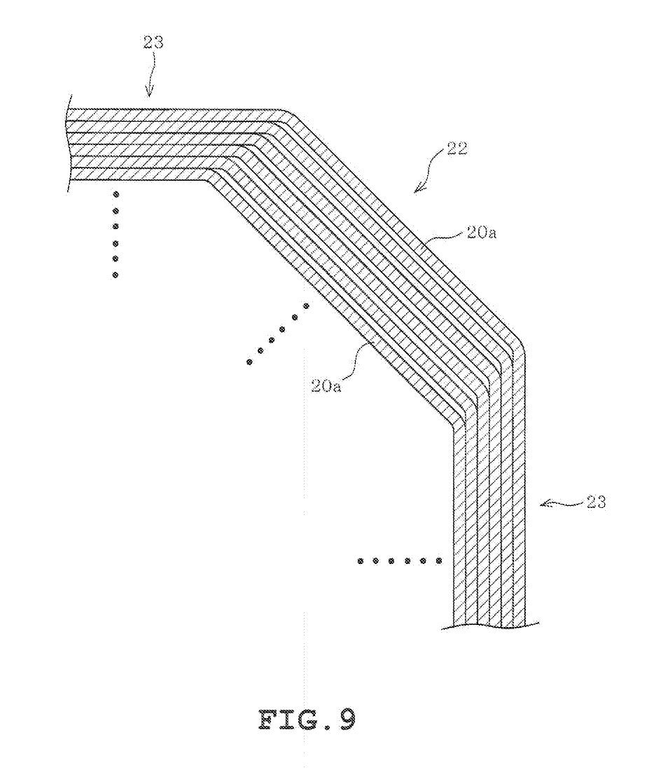

In the example of the wound core 20 illustrated in FIG. 9, the space factor of the core material 20a in the corner portion 22 is less than the space factor of the core material 20a in the side portion 23. The core materials 20a are densely laminated in the side portion 23, whereas in the corner portion 22, the core materials 20a are not densely laminated, leaving clearance between each of the core materials 20a. In this example, clearance is provided for each core material 20a.

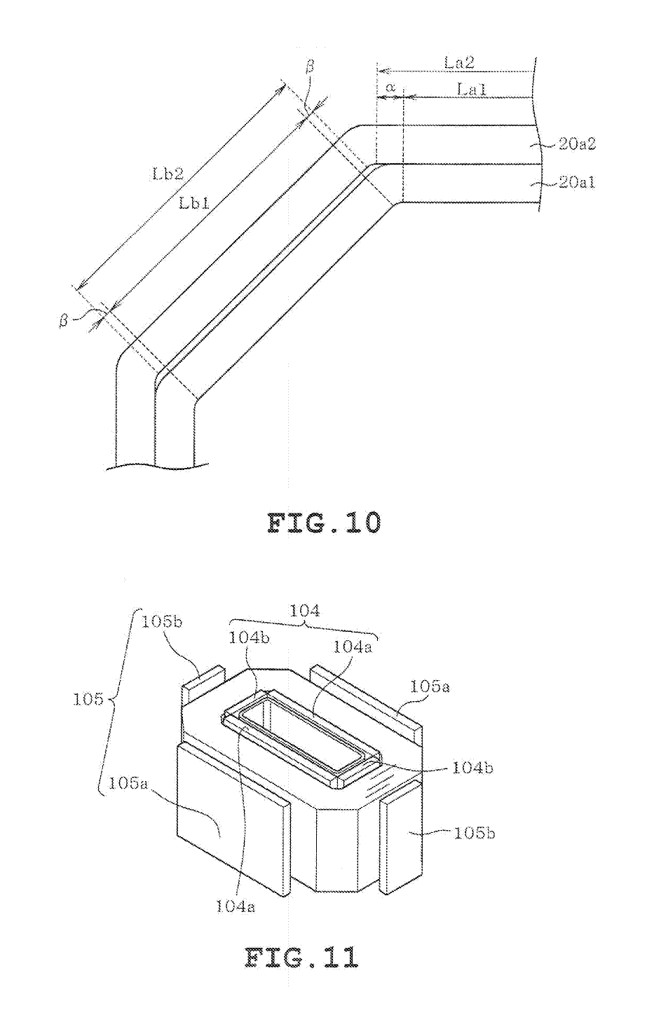

More specifically, as illustrated in the example illustrated in FIG. 10, the core material 20a2 for example is bent so that length La2 of the portion serving as the side portion 23 of the core material 20a2 is greater by a prescribed length compared to length La1 of the portion serving as the side portion 23 of the core material 20a1l located in the inner side of the core material 20a2. In this example, the prescribed amount is “2×α”. The “α” of the prescribed amount may be modified depending upon the targeted space factor of the corner portion 22 of wound core 20. The core material 20a2 is bent so that length Lb2 of the portion serving as the corner portion 22 of the core material 20a2 is greater by a prescribed length compared to length Lb1 of the portion serving as the corner portion 22 of the core material 20a1 located in the inner side of the core material 20a2. In this example, the prescribed amount is “2×β”. The “β” of the prescribed amount may be modified depending upon the targeted space factor of the corner portion 22 of wound core 20.

In the example of the wound core 20 as well, prescribed number of core materials 20a are organized into groups such as core material group 25a, 25b, . . . . More specifically, one core material group 25a, 25b, . . . is formed whenever prescribed number of core materials 20a are laminated from the inner side. The core materials 20a contained in each core material group 25a, 25b, . . . are wound so that the joint portions 24 where the cut portions are joined are circumferentially shifted from one another so as to look like a stairway. For example, location Pb of the joint portion 24 of the core material 20a wound in the innermost side of the core material group 25b is substantially or completely in alignment with location Pa of the joint portion 24 of the core material 25a wound in the innermost side of the core material group 25a adjacent to the inner side of the core material group 25b. The perimeter of Lb of the core material 20a wound in the innermost side of the core material group 25b is greater than perimeter La of the core material 20a wound in the outermost side of the core material group 25a adjacent to the inner side of the core material group 25b.

Next, a description will be given on one example of a method of manufacturing the wound core 20 having a low space factor in the corner portions 22. The method includes a silicon steel plate bending step, a silicon steel plate cutting step, a core material laminating step, wound core molding step, and a wound core anneallng step.

<<Silicon Steel Plate Cutting Step>>

In this step, the manufacturing apparatus not illustrated is configured to sequentially feed silicon steel strips by a feeder. A length of one winding amount, i.e. a length of one turn of core material 20a is sequentially cut using a cut blade from the silicon steel strip being sequentially fed.

<<Silicon Steel Plate Bending Step>>

In this step, the manufacturing apparatus not illustrated is configured to bend the core material 20a being sequentially fed using a bending machine. The core material 20a bent at the desired location as illustrated in FIG. 10 for example is obtained by making adjustments in the location of the bends. The cutting step for cutting a length of one turn of silicon steel strip may be carried out after executing the bending step in which the silicon steel strip is sequentially bent at prescribed locations.

<<Core Material Laminating Step>>

In this step, the bent core material 20a obtained from the silicon steel strip is sequentially laminated. At this instance, clearance is formed between each of the core materials 20a in the portions serving as corner portions 22 as illustrated for example in FIG. 9. In the laminating step, it is not required to densely laminate each of the core materials 20a. The core materials 20a may be loosely laminated as a whole including both the bent portions and the unbent portions.

<<Wound Core Molding Step>>

In this step, molds 104, 105 are placed in contact with four locations of the inner side and four locations of the outer side of the plural core materials 20a laminated as illustrated for example in FIG. 11. The four locations of the core material 20a are pressed in the direction of lamination by molds 104 and 105. The pressing is performed with the cut portions of the core material 20a placed in the joined state. By pressing the four locations of the core materials 20a, the side portion 23 is formed in each of the pressed portions and the corner portions 22 are formed in the remaining portions, i.e. portions that are not pressed. Because clearance is formed between each of the core materials 20a in the portions serving as corner portions 22, it is possible to absorb the deformation of core materials 20a by the pressing. It is thus, possible to prevent the cut portions of each of the core materials 20a, in other words, the joint portions 24 from opening after pressing. The joint portion 24 is formed so as to be located on the short side portion 23b. That is, each of the core materials 20a are pressed with the portions forming the joint portions 24 being clamped between the short side molds 104b, 105b.

<<Wound Core Annealing Step>>

In this step, wound core 20 is heated to a prescribed temperature of for example, 800 degrees Celsius and thereafter cooled. It is thus, possible to relax residual stress exerted on each of the core materials 20a of the wound core 20 and prevent degradation of iron-loss characteristics of the wound core 20 originating from residual stress. Each of the core materials 20a may become slightly deformed as the result of the residual stress being removed. Such deformation, if any, are absorbed by the deformation of the corner portions 22 exhibiting low space factors. It is thus, possible to prevent the joint portions 24 from being opened by the annealing step.

The above described steps manufacture the wound core 20 in which the space factor of the core material 20a in the corner portion 22 is less than the space factor of the core material 20a in the side section 23. In the wound core 20, the joint portions 24 formed by each of the core materials 20a are not opened at all and a gap is either only slightly formed at the joint portion 24 or not formed at all.

Next, a description will be given on the assembly step in which the coil is assembled with the wound core 20. In the coil assembly step not illustrated, the wound core 20 is tentatively opened at the cut portion, in other words, the joint portion 24 of each core material 20a. Then, a coil is assembled with the long portion 23a. The wound core 20 is closed so that the cut portion of each core material 20a is rejoined. As described above, there is no gap formed at the joint portion 24 of each core material 20a before the wound core 20 is opened. It is thus, possible to reproduce the wound core 20, having the coil being assembled therewith, with no gaps formed at the joint portions 24 by returning the wound core 20 to its original shape by closing the wound core 20 once opened. Thus, it is no longer necessary to carry out the conventional task of tightening the gap of the joint portion 24 when closing the wound core 20 and therefore allow the manufacturing steps to be reduced.

According to the present embodiment, the space factor of the corner portions provided in the core material of the wound core 20 is less than the space factor of the side portions provided in the portions of the core material exclusive of the corner portions. Thus, even if deformation occurs for example at the core material 20a as the result of molding or tightening the wound core 20, it is possible to absorb the deformation at the corner portions and prevent the joint portions 24 from opening. It is thus, possible to manufacture good wound cores 20 with closed joint portions 24 without having to execute precise dimensional control in each of the manufacturing steps. It is further possible to eliminate the wound core tightening step after assembling the coil for example and thereby allow the manufacturing of the wound core 20 without causing an increase in the manufacturing steps. It is further possible to prevent the joint portions 24 of the manufactured wound cores 20 from opening and thereby prevent increase in iron loss.

Further according to the present embodiment, the wound core 20 is organized by core material groups 25a, 25b, . . . each containing prescribed number of core materials 20a. The core materials 20a contained in each of the core material groups 25a, 25b, . . . are wound so that the joint portions 24 where the cut portions are joined are circumferentially shifted from one another so as to look like a stairway. Further, the location of the joint portion 24 of the core material 20a of the wound core 20 wound in the innermost side of one core material group is substantially or completely in alignment with the location of the joint portion 24 of the core material 20a wound in the innermost side of another core material group adjacent to the inner side of the said one core material group. In other words, the wound core 20 is configured so that the portions where the joint portions 24 are formed are shifted in the circumferential direction to look like a stairway. As a result, it is possible to circumferentially shift the joint portions 24 where the magnetic resistance of magnetic path become relatively large and thereby make the flow of magnetic flux at the wound core 10 to be smooth.

Further according to the present embodiment, the perimeter of the core material 20a wound in the innermost side of one core material group is greater than the perimeter of the core material 20a wound in the outermost side of another core material group adjacent to the inner side of the said one core material group. It is thus, possible to reliably reduce the space factor of the corner portion 22. It is further possible to quantitatively reduce the space factor of the corner portions 22 by controlling the perimeter of each core material 20a.

Further according to the manufacturing method of the wound core of the present embodiment, the core materials 20a, each having one cut portion for every one winding thereof and having portions forming the corner portions 22 being bent, are loosely laminated and a window portion 21 is formed in the center with the cut portions of each of the core materials 20a joined. According to the manufacturing step, one core material is bent, prior to laminating the core materials 20a, so that the length of the portion serving as the side portion of the one core material is greater by a prescribed length compared to the length of the portion serving as the side portion of another core, material located in the inner side of the said one core material. Further according to the manufacturing step, one core material is bent, prior to laminating the core materials 20a, so that the length of the portion serving as the corner portion of the one core material is greater by a prescribed length compared to the length of the portion serving as the corner portion of another core material located in the inner side of the said one core material. According to the manufacturing method, it is possible to carry out steady manufacturing of wound cores 20 in which the space factor of the core material 20a in the corner portion 22 is less than the space factor of the core material 20a in the side portion 23 exclusive of the corner portions 22.

According to an embodiment described above, a wound core is provided with plural wound core materials each having at least one cut portion for every one winding thereof, and the wound core is provided with a rectangular window portion at the center thereof. The space factor of the core materials at the corner portions is less than the space factor of the core materials at the side portions exclusive of the corner portions.

According to an embodiment described above, a method of manufacturing a wound core includes loosely winding plural core materials each having at least one cut portion for every one winding thereof; and closing the cut portion of each core material to form a rectangular window portion at the center of each core material and thereby causing a space factor of the core material in corner portions of the core material to be less than a space factor of the core material in side portions of the core material.

According to an embodiment described above, a method of manufacturing a wound core loosely laminates plural core materials, each having at least one cut portion for every one winding thereof and having portions forming corner portions thereof being bent. The at least one cut portion of each core material is closed to form a rectangular window portion at the center of each core material and thereby causes a space factor of the core material in a corner portion of the core material to be less than a space factor of the core material in a side portion of the core material exclusive of the corner portion. The method bends the core materials prior to laminating the core materials and thereby causes the portions forming the side portions of one core material to be longer by a prescribed length than portions forming the side portions of another core material located in an inner side of the one core material, and causes the portions forming the corner portions of one core material to be longer by a prescribed length than portions forming the corner portions of another core material located in an inner side of the one core material.

It is thus, possible to carry out the manufacturing process without having to execute precise dimensional control in each of the manufacturing steps, without causing an increase in the manufacturing steps and also preventing increase in iron loss.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Core materials are not limited to those having one cut portion for every one winding thereof but may have plural cut portions for every one winding thereof. That is, a core material having at least one cut portion for every one winding thereof falls within the technical idea of the embodiments.

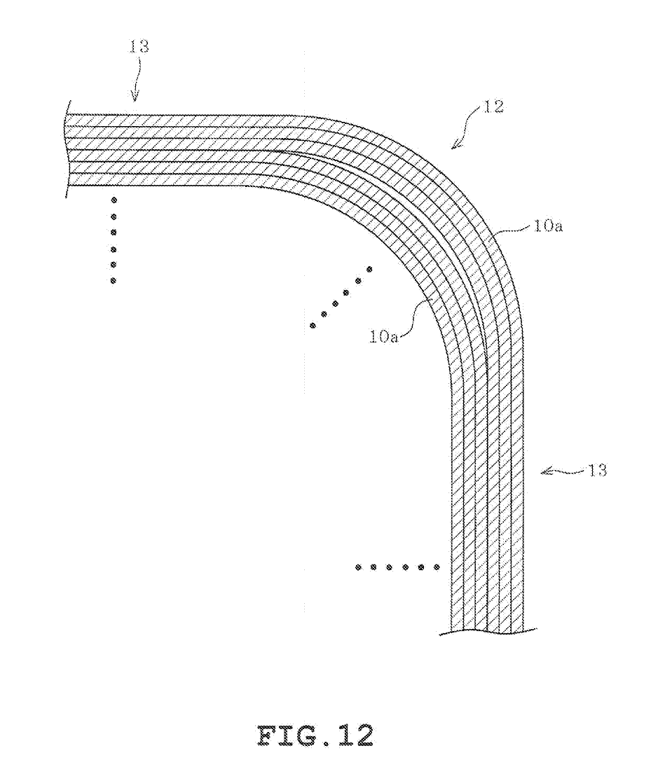

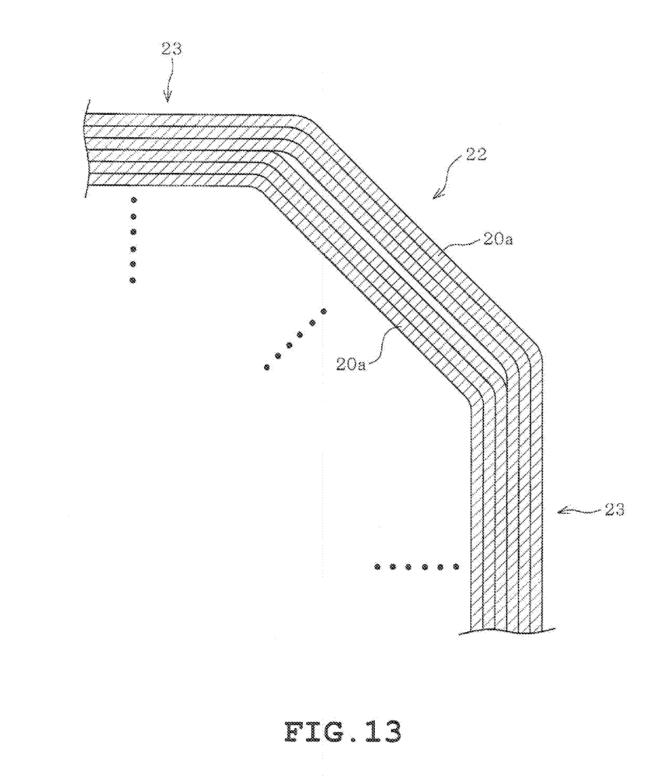

The wound core 10 may be configured so that a clearance is provided at the corner portion 12 for every plural core materials 10a as illustrated in the example of FIG. 12. The wound core 20 may be configured so that a clearance is provided at the corner portion 22 for every plural core materials 20a as illustrated in the example of FIG. 13. The count of core material(s) 10a or core material(s) 20a disposed between the clearances may be modified as required. For example, a clearance may be provided between the core material groups described above. Though not illustrated, the wound core maybe configured so that a region provided with a clearance for every one core material and a region provided with a clearance for every plural core materials co-exist in the corner portion.

What is claimed is:

1. A wound core being provided with plural wound core materials each having at least one cut portion for every one winding thereof, the wound core being provided with a rectangular window portion at the center thereof, the wound core comprising:
corner portions provided at four corners of the window portion; and
side portions connecting the corner portions;
a space factor of the core materials at each of the corner portions being less than a space factor of the core materials at each of the side portions.

2. The wound core according to claim 1, wherein every prescribed count of core materials are organized into a core material group to form plural core material groups, the core materials provided in each of the core material groups being wound so that a joint portion joining the cut portion of each core material is shifted circumferentially from one another like a stairway,
wherein a location of the joint portion of the core material wound in the innermost side of one core material group is in alignment with a location of the joint portion of the core material wound in the innermost side of another core material group located in an inner side of the one core material group, and
wherein a perimeter of the core material wound in the innermost side of one core material group is greater than a perimeter of the core material wound in the outermost side of another core material group located in an inner side of the one core material group.

3. The wound core according to claim 1, wherein portions of the core materials forming the corner portions are bent, and
wherein portions forming the side portions of one core material are longer than portions forming the side portions of another core material located in an inner side of the one core material and
wherein portions forming the corner portions of one core material are longer than portions forming the corner portions of another core material located in an inner side of the one core material.

4. The wound core according to claim 1, wherein, in the corner portions, a clearance is provided between every core material.

5. The wound core according to claim 1, wherein, in the corner portions, a clearance is provided for every plural core materials.

6. A method of manufacturing a wound core comprising:
loosely winding plural core materials each having at least one cut portion for every one winding thereof; and
closing the at least one cut portion of each core material to form a rectangular window portion at the center of each core material and thereby causing a space factor of the core material in corner portions of the core material to be less than a space factor of the core material in side portions of the core material.

7. A method of manufacturing a wound core in which plural core materials, each having at least one cut portion for every one winding thereof and having portions forming corner portions thereof being bent, are laminated, and in which the at least one cut portion of each core material is closed to form a rectangular window portion at the center of each core material and thereby causing a space factor of the core material in corner portions of the core material to be less than a space factor of the core material in side portions of the core material, the method comprising:
bending the core materials prior to laminating the core materials and thereby causing the portions forming the side portions of one core material to be longer than portions forming the side portions of another core material located in an inner side of the one core material, and causing the portions forming the corner portions of one core material to be longer than portions forming the corner portions of another core material located in an inner side of the one core material.
